(19) United States
(12) Patent Application Publication
(10) Pub. No.: US 2015/0162607 A1
(43) Pub. Date: Jun. 11, 2015

(54) DeBottis Energy Cell

(71) Applicant: John Russell DeBottis, Marcellus, NY (US)

(72) Inventor: John Russell DeBottis, Marcellus, NY (US)

(73) Assignee: John Russell Debottis, Marcellus, NY (US)

(21) Appl. No.: 14/102,759

(22) Filed: Dec. 11, 2013

(51) Int. Cl. H01M 4/38; H01M 10/28; H01M 2/12; H01M 4/90; H01M 2/02

(52) U.S. Cl. CPC H01M 4/38; H01M 4/90; H01M 2/02; H01M 2/1223; H01M 2/0202; H01M 2/0237; H01M 10/28

(57) ABSTRACT

The invention is an energy cell similar to the fuel cell technology it surpasses in lifecycle usage and in generating energy on the need. The energy cell is used to power utility lines, transportation, and heating. The main components is the carbon zinc rods that transfer the harvesting of thermal conductive energy from molecules friction force and then transfer that kinetic force into electrical output for any electrical devices requirement and revamps the short circuit issue in previous fuel cell technology.

### CROSS-REFERENCE TO RELATED APPLICATION

Not Applicable

### FEDERALLY SPONSERED RESEARCH

Not Applicable

### SEQUENCE LISTING OR PROGRAM

Not Applicable

### BACKGROUND OF THE INVENTION

(A) Field of the Invention

The DeBottis Energy Cell invention relates to the Energy Cell Technology, and more particularly to the method and process for creating the structure and design of the apparatus, that provides renewable thermodynamic heat transfer exchange that is processed into electrical current.

(B) Description of the Related Art

An electrochemical and mechanical flaw has been reported by the Department of Energy recently that fuel cells are not meeting the required standards. The reason is for their mechanical and electrochemical design flaw that prevents the fuel cell to operate at variable temperatures without the major loss in cell energy through the process of kinetic heat transfer when the cellular decay of the rods occur that results in a short circuit.

All fuel cells are composed of five basic components two electrodes on which the fuel-cell reaction occurs, two gases supply the means to which supply the fuel and oxidant to the respective electrodes, and electrolyte that transfers the ions, formed by the electrode reactions, from one electrode to the other. The Alkaline or intermediate temperature fuel cell is characterized by its normal use of oxygen and hydrogen as the fuel during the oxidation process large amounts of heat is released towards the electrodes; however because of the poor materials used they are only capable of collecting' of one percent of that large amount of heat release from the oxidant process.

However, all fuel cells suffer from the material flaw design they used metals such as “Nickel, Brass, Copper, Zinc, Platinum, and Aluminum” these metals break down in alkaline acids that occur from the result of the oxidation process. This results in the short circuit of the fuel cells and directly affects the consumer with defective product that they have to return to the manufacture.

### SUMMARY OF THE INVENTION

Therefore, an object of the invention is to provide a change in material from full metallic element electrodes to semi-metallic element electrodes that improves operations of the cell and removes the manufacture defect thereby eliminating the short circuit in the cell. The result of this improvement increases energy production and allows for the direct thermal harnessing of the kinetic energy to be transformed directly back into electric current.

### BRIEF DESCRIPTION OF THE DRAWINGS

In the drawings, each part has been labeled and numerically cross reference to a reference table provided.

FIG. 1—DeBottis Energy Cell Interior—(Fragmented Embodiment View)

FIG. 2—DeBottis Energy Cell Exterior View—(Embodiment View)

FIG. 3—DeBottis Energy Cell Logic View—(Logic Process View

Drawings - - Reference Numerals

10. DeBottis Energy Cell
12. Chemical Solution
14. Carbon Rods
16. Copper Caps
18. Cap/Carbon Rod Bonding Process
20. Electrical Wires Connections
22. Ventilation Process
24. Battery Storage or Power Supply
26. Utility Output Power Gain
28. Lead Protective Thermal Casing
30. Rod Support Structure Brackets
32. Hex bolts access repair hatch
34. Plastic Polymer Retainer wall
36. Electrical Automated Ventilation Cap

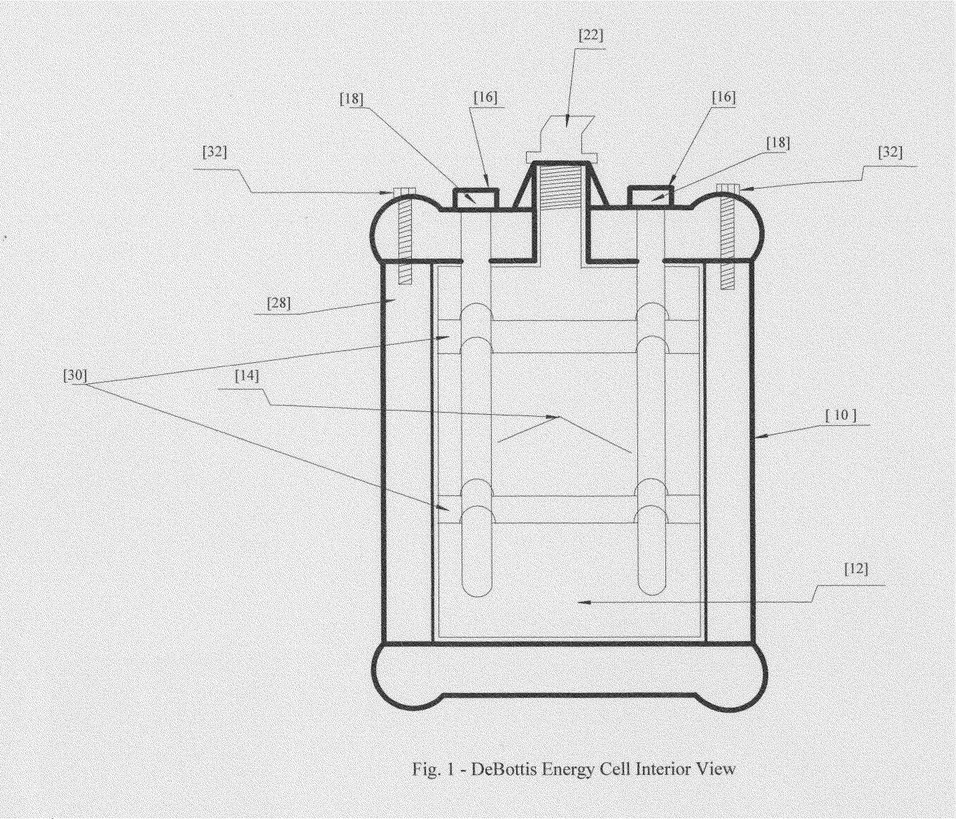

### DETAILED DESCRIPTION—FIG. 1—DEBOTTIS ENERGY CELL INTERIOR VIEW

A preferred embodiment of the layout of the present invention is illustrated in FIG. 1 (Fragmented View). The DeBottis Energy Cell 10 is composed of a combination of materials that allow for its unique ability to with stand environmental conditions while being capable of producing large energy gains The cell 10 consists of a 12 Alkaline Solution that is superior to the bacon cell design and demonstrates thermal energy transfer from molecular slides, these slides are tiny in nature and reoccurring while 24 Power supply is there to produce the thermal separation and re-bonding of the 12 Alkaline solution. The rods 14 are composed of (Zinc-Carbon) that allows for busing the electrical current and harnessing the energy gained, these rods are unique in design they do not decay in the alkaline solution do to their semi-metallic state. Attached to the rods 14 is a cap 16 that consists of the element copper to allow for soldering connection 20 of the wires. The cap 16 is adhesive 18 to the carbon zinc rod 14 this provides a secure connection process that will with stand the PSI—pressure within the cell 10.

The wires 20 consist of one anode and one cathode, the anode is connected to the Hydrogen Ions and the cathode is connected to the oxygen that 14 the rods produce a circuit that buffers the Ion exchange across the matrix that are placed a certain distance apart to allow for a current within 10 the Cell. The solution 12 is encased in a 34 plastic polymer that does not decay, around this polymer 34 is a 28 lead protective thermal casing that allows for utility protection against the weather and around the users general safety design. Mounted to 34 plastic walls is a 30 rod support structure bracket that allows for general safety of 14 carbon rods to act as buffer from shifting the brackets 30 provides an elastic buffer to transfer forces that may occur while moving the cell 10 during travel from place to place. The repair hatch to the cell is on the top by removing 32 the hex bolts you can repair the cell 10 these bolts are covered by bolt caps to prevent weathering or corrosion of the repair hatch bolts.

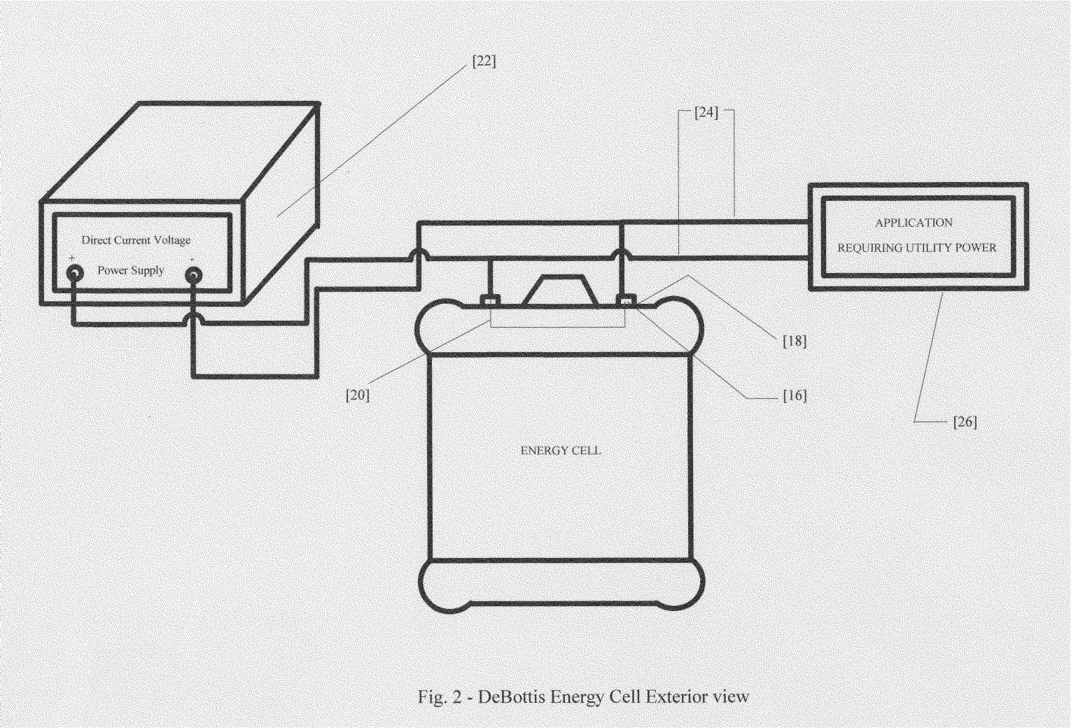

### DETAILED DESCRIPTION—FIG. 2—DEBOTTIS ENERGY CELL EXTERIOR VIEW

The exterior of the DeBottis Energy Cell 10 is composed of lead protective thermal casing 28 that is designed to control the ambient adjusting temperature against the climate conditions that would decrease the utility output power gain 26 for temperatures below freezing. On top of the cell 10 is two copper caps 16 that are connect to the carbon rods 14 one anode and one cathode that connects in parallel circuit through electrical wires connections 20 to the battery storage or power supply 24 that controls the input power that is amplified by the cell 10 through a thermal release of energy from the separation and re-bond process of the chemical solution 12 that release a amplified utility output power gain 26 that is capable of running a AC motor or AC lighting.

The cell 10 exterior may vary in shape or size; however it is not to affect the scope of the process in which the cell 10 may generate utility output power gain 26 from the chemical solution 12 that must be protected by the lead protective thermal casing 28 to prevent failure to start in uncontrolled temperature conditions. To control the PSI within the cell 10 an electrical automated ventilation cap 36 has been installed to open during startup and to shut when powered off.

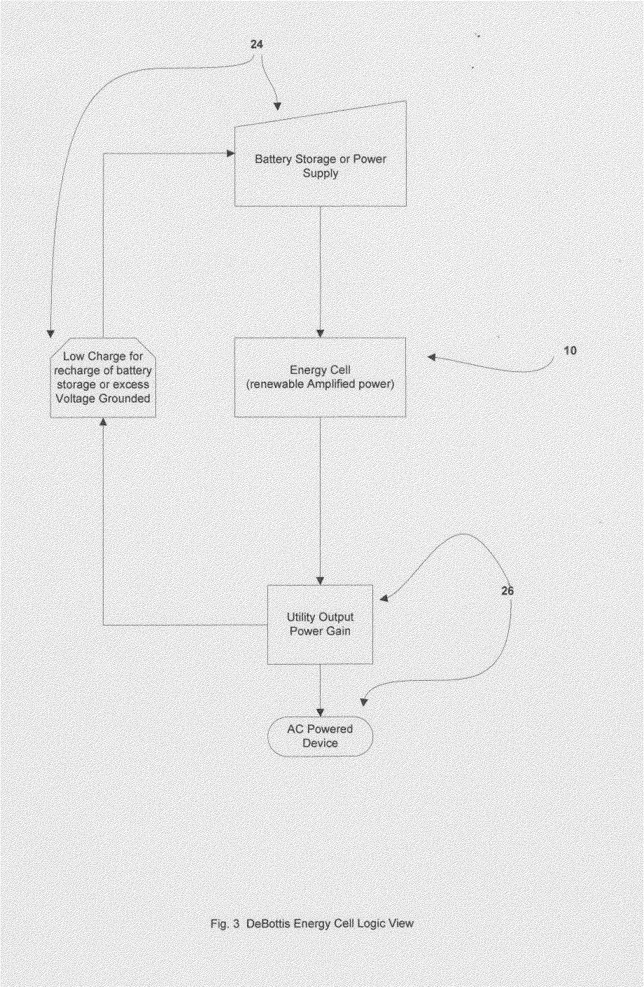

### DETAILED DESCRIPTION—FIG. 3—DEBOTTIS ENERGY CELL LOGIC VIEW

The cell 10 is described in logic steps through a basic flow chart of operations to provide a more detailed understanding of the logic behind the cell 10. The logic process starts with the battery storage or power supply 24 that begins the energy cell 10 process where the utility output power gain 26 is now in the form of alternating current and amplified 5.9 times to run AC powered device.

### ADVANTAGES

From the description above, a number of advantages of DeBottis Energy Cell became evident such as:

(a) Other energy cell break down in the alkaline process that decays the metallic metals, carbon rods with stand the alkaline process and act as thermal buffers to access more energy that is normally lost in other design of metallic.

(b) The lead protective thermal casing keeps the energy cell working at full capacity during subzero temperature where as with other manufactures there fuel cells have loss gain during the cold. The lead protective thermal casing improves the old models to now work in all temperatures while providing thermal security to maintain 100 percent effectiveness of the energy cell.

(c) The utility output power in other fuel cell's similar to this are under 4 percent effectiveness while this new design allows for 100 percent chemical energy to generate Alternating current in large scale that even over excels beyond the NASA design in 1950's bacon cell.

(d) Allows for double energy storage on the alkaline 9 volt battery by compressing more charge energy back on to non-rechargeable alkaline batteries. While also recharging the battery so that it retains a shelf life two point five year's longer than current process.

(e) The ventilation process with automatic psi release is a new design and improving on the older design in patent process where they did not have proper ventilation and regulating design for the safety of the psi by introducing automatic venting during power on and ventilation closing during power off state.

I claim:

1. Therefore, an objective of the DeBottis Energy Cell invention is to provide a change in material from full metallic elements electrodes to semi-metallic element electrodes that improves operations of the cell and removes the manufacture defect thereby eliminating the short circuit in the cell. The result of this improvement increases energy production and allows for the direct thermal harnessing of kinetic energy to be transformed directly back into current.

2. The closure of claim 1 wherein said short circuiting of fully metallic rods is replaced by semi-metallic carbon rods to remove the decay of rods that result in short circuit of fuel cell's and energy cell.

3. The closure of claim 2 the production of alternating current that is useable for utility grade applications and devices powered by alternating current.

4. The closure of claim 3 the improved lead thermal protective casing that blocks subzero temperature from effecting the energy cell's operation.

5. The closure of claim 4 the improved Electrical automated ventilation cap that releases psi pressure in safe operations during power on of energy cell and closes during power off of energy cell.

6. The closure of claim 5 the recharging of non-rechargeable alkaline class batteries and the ability to store double power on recharge of 9 volt alkaline where the energy is compressed in storage.
